(19) United States
(12) Patent Application Publication
(10) Pub. No.: US 2003/0046363 A1
(43) Pub. Date: Mar. 6, 2003

(54) Method and system for making and updating home page

(76) Inventor: Masahiro Ezato, Fukuoka (JP)

Correspondence Address: RATNERPRESTIA, P O BOX 980, VALLEY FORGE, PA, 19482-0980, US

(21) Appl. No.: 10/179,943

(22) Filed: Jun. 26, 2002

(30) Foreign Application Priority Data
Jun. 29, 2001 (JP) 2001-198184
Aug. 31, 2001 (JP) 2001-263275

(51) Int. Cl. G06F 15/16

(52) U.S. Cl. 709/218; 709/203

(57) ABSTRACT

One or more layout blocks are provided in a format of a home page to be registered in a Web server. A mail address for indicating a producing and updating of the home page, a user ID assigned to a facsimile telephone number, and image and mark-sheet data provided on a home page producing/updating draft sheet are transmitted from a facsimile device to a CTI server. The CTI server extracts block data from the received data and converts a format of the image data. Data in a mark-sheet form has its instruction recognized from a location of the data, and the instruction is sent to the Web server. The Web server writes the received data into the layout blocks for producing and updating the home page.

### FIELD OF THE INVENTION

The present invention relates to a technology for updating content data of a home page on the Internet.

### BACKGROUND OF THE INVENTION

As network technologies have remarkably progressed, Internet related innovations have widely spread.

Over the Internet, browser software installed in personal computers (referred as computers hereinafter) or other applicable mobile terminals can access a variety of home pages provided in World-Wide-Web sites. Connection to the Internet is hence mandatory for the computers or applicable mobile terminals.

Most end-users simply receive desired data from the Internet, while only a few can provide their home pages and serve as data sources. Most end-users have some difficulty in producing their home pages since they need basic knowledge about computers, home page producing software, and networks. Some active end-users ask specialists to produce their home pages. However, producing and updating of home pages is expensive. This prevents popularization of home pages.

Because the production of home pages is a troublesome task, its global use has been limited to data providing business over the Internet. If every individual subscriber could have his/her own home page, he/she could provide desired information and thus have a chance of getting business like a large enterprise can.

Some public services are available to produce free of charge the home page of a small shop or of a person who owns no computer or facsimile equipment.

However, even if a home page of a small shop or individual has been produced and introduced to the network, it may face some troubles. The home page has to be updated to provide the latest information, and if it is not, will decline in quality and decreasingly be accessed by others on the network. If the home page is not updated by the owner, its out-of-date information, e.g. daily prices offered by the shop, may be exposed, resulting in the loss of money and the loss of the effect of the advertisement. It is quite difficult for an individual subscriber who is unfamiliar with the Internet to update a home page almost daily if a structure of the home page is not simple for both production and updating.

In the case where the home page of an individual who owns no computer or facsimile equipment is produced and published by a public organization, the original information has to be transferred directly or by telephone from the individual to the organization. The original information that was converted to electronic form can be accessed only by the organization or over the network, because the home page was published by the organization but not by the individual. Consequently, the home page cannot modified directly by the individual. More particularly, the home page of each shop or individual subscriber is inserted as a Web page at a lower level into a top page which is published and operated by the organization acting as an upper level user.

The original information of the home page has to be manually drafted by the individual and handed to the organization. The original information is generally written in no particular form. This will result in more labor by the organization to convert the original information into the home page.

At present, a data device used most commonly by a small shop or individual subscriber is a telephone or a facsimile device. The facsimile device is popular among people who are not familiar with household computers, and is used as a data communication device. If the facsimile device is linked to the Internet and used for operating/updating the home page, every small shop or individual subscriber can favorably promote its business.

Japanese Utility Model No.3059894 discloses a technique for automatically scanning hand-made originals, without any manual computer entry action, to provide a home page on the Internet. A home page draft sheet is prepared, and item areas of the home page draft sheet are filled with desired texts and image data such as photos and illustrations. Then, a title, transmitter/receiver facsimile number, and keyword are written on the home page draft sheet. The draft sheet is transmitted from the transmitter/receiver facsimile via a telephone network to home page editing means which comprises a facsimile server, facsimile image modifying means, home page producing means, and home page returning means. Written contents of the home page draft sheet are automatically converted by the home page editing means into data in an Internet display format which includes the home page and a home page address.

However, this technique using a uniform model of the home page draft sheet needs to fill the sheet with desired hand-written texts, photos, and other images as well as the title, transmitter/receiver facsimile number, and keyword which are then scanned through text recognition of an optical character reader (OCR) before its character data is particularly corrected. Since the character recognition with any OCR is generally not precise, the resultant home page may contain some faults in the text.

### SUMMARY OF THE INVENTION

In a method of producing/updating a home page, the following steps are executed. A facsimile device transmits, to a server unit, image data and mark-sheet data written on a home page producing/updating a draft sheet which has a home page data area, a caption data area, and a mark-sheet setting area. The server unit converts a format of the transmitted image data. The server unit recognizes an instruction from a location of the mark-sheet data in the mark-sheet data setting area. The server unit writes the image data into a layout block of a home page for producing or updating the home page. The server unit extracts a caption image from the caption data area. The server unit writes the caption image into a caption-listing sub-block in the layout block on a top page of the home page.

The method of producing/updating a home page allows a subscriber who has no particular knowledge about computers nor the Internet to produce and update its home page easily and inexpensively without disturbing a home page operator. The caption image can be shown on a top page of the home page as received.

### BRIEF DESCRIPTION OF THE DRAWINGS

FIG. 1 is a schematic view of a facsimile device in a system for producing/updating a home page according to an exemplary embodiment of the present invention.

FIG. 2 is a block diagram of the facsimile device in the system for producing/updating a home page according to the embodiment.

FIG. 3 illustrates a home page production/update draft sheet for system for producing/updating a home page of the embodiment for transmitting desired data.

FIG. 4 is a flowchart showing dialogs between the facsimile device and a server in the system for producing/updating a home page according to the embodiment.

FIG. 5 is a block diagram of a computer telephony integration (CTI) server in the system for producing/updating a home page according to the embodiment.

FIG. 6 is a block diagram of a Web server in the system for producing/updating a home page according to the embodiment.

FIG. 7 illustrates an e-mail to be transmitted from a communication system in the system for producing/updating a home page according to the embodiment.

FIG. 8A illustrates a home page produced by the communication system in the system for producing/updating a home page according to the embodiment.

FIG. 8B illustrates home page producing parameters provided in the communication system in the system for producing/updating a home page according to the embodiment.

FIG. 8C illustrates a top page produced by the system for producing/updating a home page according to the embodiment.

FIG. 9A illustrates a caption data table provided in the system for producing/updating a home page according to embodiment.

FIG. 9B illustrates the relationship between user IDs and their names provided in the system for producing/updating a home page according to the embodiment.

FIG. 10 is a flowchart of a procedure implemented by the communication system in the system for producing/updating a home page according to the embodiment.

### DESCRIPTION OF THE PREFERRED EMBODIMENT

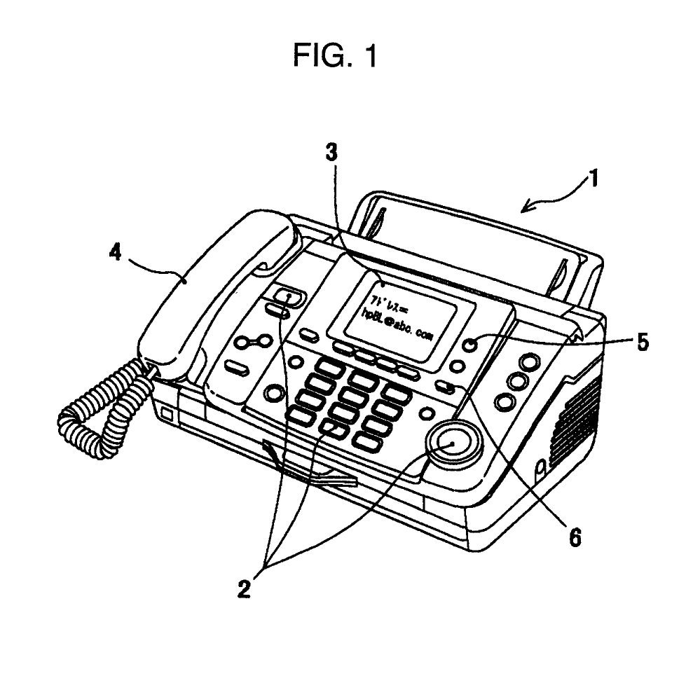

FIG. 1 illustrates a facsimile device 1 according to an exemplary embodiment of the present invention. An operating panel 2 can control calling through an operation dial and keys. A liquid crystal display (LCD) 3 displays a menu to make functional selections through the operating panel 2 and a dialog in a home page producing/updating mode. A handset 4 is provided for voice communication by a user. An E-mail button switch 5 is pressed for selection of a mode for sending an E-mail. A transmission (start) button 6 is pressed for sending a facsimile message or E-mail to a computer telephony integration (CTI) server.

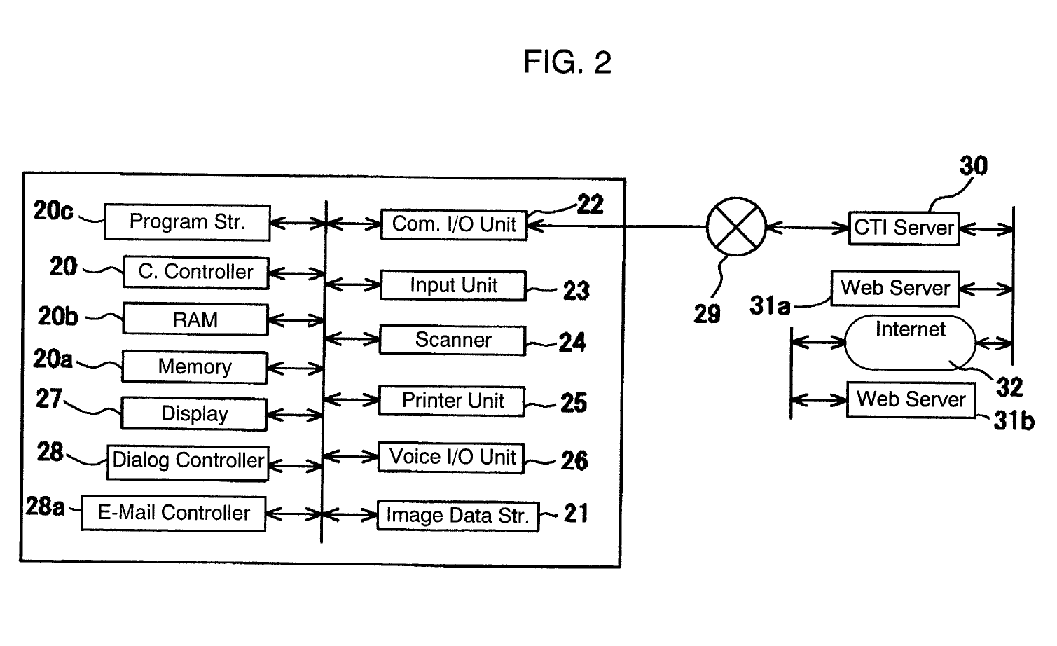

FIG. 2 is a block diagram of the facsimile device in the system for producing/updating a home page according to the embodiment. A memory 20a, such as an nonvolatile memory, stores various control settings used for controlling by a central controller 20. A RAM 20b serves as a work area for the central controller 20. A program storage 20c stores programs, and is used by the central controller 20 for controlling operations of the facsimile device and the entire system. An image data storage 21 stores both data received from the communication network and transmitting data scanned with a scanner 24. A communication input/output unit 22 exchanges protocol data and transmits/receives data between the facsimile device and the telephone network. An input unit 23 is controlled with the operating dial and keys for input supply of input signals to the central controller 20. Through the input unit 23, functional controls with the keys are input, and the display of menus simultaneously or separately on the LCD 3 is selected (with the cursor) and initiated by the operating key.

The operating panel 2, the input unit 23, and the transmission button 6 are incorporated to home page producing mode selecting means of the embodiment. When the operating dial of the operation panel 2 is turned on, and when the input unit 23 is activated for providing input signals, the LCD 3 displays a home page producing/updating mode which is initiated by the transmission button 6. In the home page producing/updating mode and an E-mail sending mode, signals are input in a dialog form as described later in more detail.

The scanner 24 for reading out the original draft is implemented by an array of CCD line image sensors according to the embodiment. A printer unit 25 operates in a facsimile mode or a copy mode for printing a facsimile message received or scanned data read out by the scanner 24. The facsimile device 1 further includes a display 27 for displaying the menus and the dialogs on the LCD 3. A dialog controller 28 displays and controls the dialogs in the home page producing and updating mode and the E-mail sending mode for a user to input an instruction.

An E-mail controller 28a controls transmission and reception of E-mails. For example, the E-mail controller 28a for controlling the transmission and reception of E-mails, upon receiving an E-mail, can display the received E-mail on the LCD 3. In a E-mail sending mode, the controller can automatically transmit a user ID (an address name of the user) and the security ID stored in the memory 20a. The facsimile device 1 is linked to a public telephone network 29.

The computer telephony integration (CTI) server 30 produces an E-mail from the data which is received from the facsimile device in the home page producing/updating mode and the E-mail sending mode. The CTI server 30 is connected to or arranged integral with a Web server 31a to which each home page is registered. Those servers are linked to the Internet 32.

The Web server 31a is connected through the Internet 32 to a Web server 31b in another provider. The home page is usually registered to the Web server 31a connected to or arranged integral with the CTI server 30. The home page may be registered to another Web server 31b.

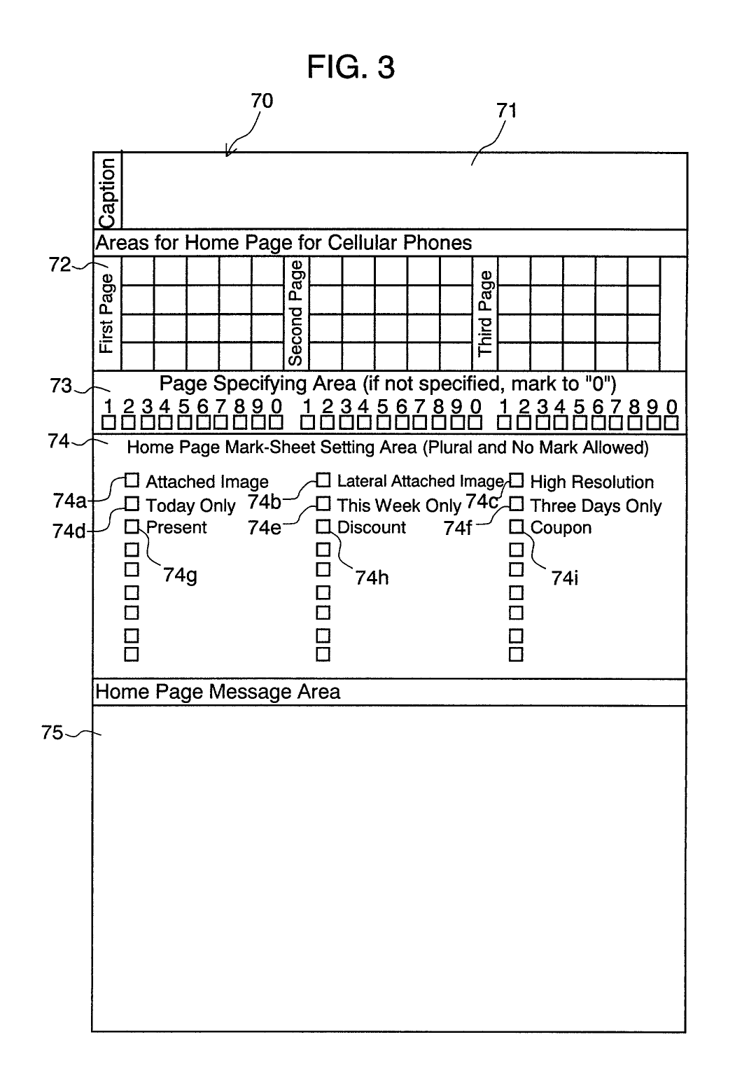

A home page producing/updating draft sheet to be transmitted from the facsimile device according to the embodiment will be described. As shown in FIG. 3, the home page producing/updating draft sheet 70 is transmitted from the facsimile device to the CTI server 30. The home page producing/updating draft sheet 70 is filled by the user with relevant information including images to be displayed and mark-sheet data of, e.g. the instruction and the settings. The sheet 70 filled with the information is facsimile-transferred to the CTI server 30.

The CTI server 30 extracts the image data from the draft sheet and sends it to the Web server 31a (31b) for displaying it on the home page. A marked location (position data) of the mark-sheet in the draft sheet is recognized by the Web server 31a (31b) to recognize an instruction corresponding to the position data. The instruction according to the position data is performed on the image data for producing and updating the home page.

The home page producing/updating draft sheet 70 shown in FIG. 3 includes a caption area 71 where a caption message, e.g. “Today Is Sale Day”, is written by hand. The caption area may be limited to a predetermined area, e.g. 1 to 3 cm from the top, 3 cm from the left end, and 8 cm from the right end of the sheet to be transmitted from the facsimile device, and read out by a data processor 43b.

A message filled in a mobile telephone home page message area 72 is received as image data and can thus be displayed as the home page on the small display of a mobile telephone. In this embodiment, the message may be expressed by characters to be displayed as text data.

Moreover, the home page producing/updating draft sheet 70 has a page specifying area 73 in a mark-sheet form where (the number of) Web pages in the home page is specified. The numerals in the page specifying area 73 are marked up for discriminating the home page screens (Web pages) of subscribers at a lower level from a top page of the home page provided by, e.g. a home page provider/operator, a community business society, or a public organization. This allows a desired page to be easily specified. Also, if the home page of each subscriber includes lower level pages, the pages can be selected easily through marking down in the page specifying area 73.

The CTI server 30 or the server identifies the number of pages from two pieces of data: the user ID (or the facsimile number); and the numeral in the page specifying area 73. If the page specifying area 73 has no markup signs, the top page is only displayed. More specifically, the top page of each home page is assigned to a highest level user identified by the user ID. If the Web page is a continuing page of the lower level user and/or the upper level user which is not tagged with a user ID, the number in the page specifying area 73 represents the continuing page of the lower level user and/or the upper level user.

The number of Web pages of each small shop or individual subscriber received from the facsimile device is a predetermined number. When a particular Web page of the subscriber needs to be updated or inserted as a continuous page after the top page, the number is written in the page specifying area 73.

As the number of pages of the lower level increases, the identification of a desired page with the use of a row of numerals has to be modified, hence permitting the number of Web pages of each subscriber to be set to a particular number. If a page is to be inserted, the numerals are rearranged by the CTI server 30 or the server. This does not allow the subscriber to respond to any change in the number of Web pages. When the number of Web page users is small, each Web page user may be assigned to a single page with page information given from the page specifying area 73 of the draft sheet.

The draft sheet 70 has a home page registering mark-sheet area 74 where the mark-sheet settings instruct the Web server 31a (31b) via the CTI server 30 for producing and updating the home page. The CTI server 30 examines the location of the mark-sheet settings and relates the mark-sheet settings with their services. The home page registering mark-sheet area 74 of the draft sheet 70 includes an attached image box 74a, a lateral attached image box 74b, and a high-resolution registering box 74c for an attached image.

When the attached image box 74a is marked, the image data of the next page listed in the home page producing/updating draft sheet 70 is read, and any other data provided in a home page message area 75, explained later, is deleted. When the lateral attached image box 74b is marked, an image or attached image provided in the home page message area 75 is laid down on the side and added to the home page. When the high-resolution registering box 74c is marked, the image to be added to the home page is instructed to shift to a high resolution. In general, the image data of the home page is compressed to ⅕ by a data converter 43 before being transferred from the CTI server 30 to the Web server 31a (31b). When the image data is registered as high resolution, its size is reduced to substantially ½ with no use of the normal compressing.

A daily-period registering box 74d in the home page producing/updating draft sheet 70 limits the availability of produced and updated information on the home page to one day. A weekly-period registering box 74e limits the availability of information on the home page to one week. A three-day period registering box 74f limits the availability of information on the home page to three days. Instructions with the daily period registering box 74d, the weekly period registering box 74e, and the three-day period registering box 74f allow the subscriber to delete and update the information on the home page easily. For example, the information about special sale of a small shop can automatically be deleted by the Web server 31a (31b) when its period has passed. A premium data box 74g, a discount data box 74h, and a coupon data box 74i carry retrieval key data. When they are marked, their data are set up. Accordingly, the data can easily be accessed with the corresponding retrieval keys actively displayed on the top page of the home page. A text or an image added in the home page message area 75 is directly input as the image data and displayed on the home page. When the home page message area 75 is filled with a message, and when the attached image area 74a remains not marked, the home page can be produced and updated simply from the single home page producing/updating draft sheet 70.

The home page producing/updating draft sheet 70 is not limited to that shown in FIG. 3 which includes the areas described in above. The home page producing/updating draft sheet 70 may include only a desired number of the areas according to a request. For example, the home page producing/updating draft sheet 70 may include only the caption area 71, the page specifying area 73, and the home page registering mark-sheet area 74, which are not applicable to cellular telephones. Alternatively, the home page producing/updating draft sheet 70 may include only the mobile telephone home page message area 72 for use with cellular telephones. The home page producing/updating draft sheet 70 may include only the home page message area 75 to be used freely. The home page producing/updating draft sheet 70 may carry any other areas for filling desired items.

A procedure for inputting data with the facsimile device according to the embodiment for producing and updating a home page with the home page producing/updating draft sheet 70 in conjunction with messages displayed on the LCD will be described.

Before a home page is produced, data for producing an E-mail is transferred from the facsimile device to the CTI server 30 for setting the user ID, the security ID, and the E-mail address.

The facsimile device is assigned a facsimile telephone number, about which the CTI server 30 (a provider) is notified. In turn, the CTI server 30 registers the number and sends the user ID (the name and address of a user) and the security ID to the facsimile device. If the home page is controlled by a community business society or a public organization which appears on the top page, registration and acquisition of the user ID and the security ID are conducted by them but not by each subscriber. Each subscriber or small shop acts as a data source for providing a Web page following the top page of the home page. The security ID received is stored in the memory 20a of the facsimile device. The security ID is assigned to each machine and is automatically attached together with the user ID to the E-mail which is then sent. Then, upon receiving a facsimile message including the user ID which requests a home page service, the provider having the Web server 31a allows the user to register and set up the home page requirements. As explained later in more detail, the provider notifies the user of its uniform resource locator (URL) for producing the home page. The preparatory action is completed.

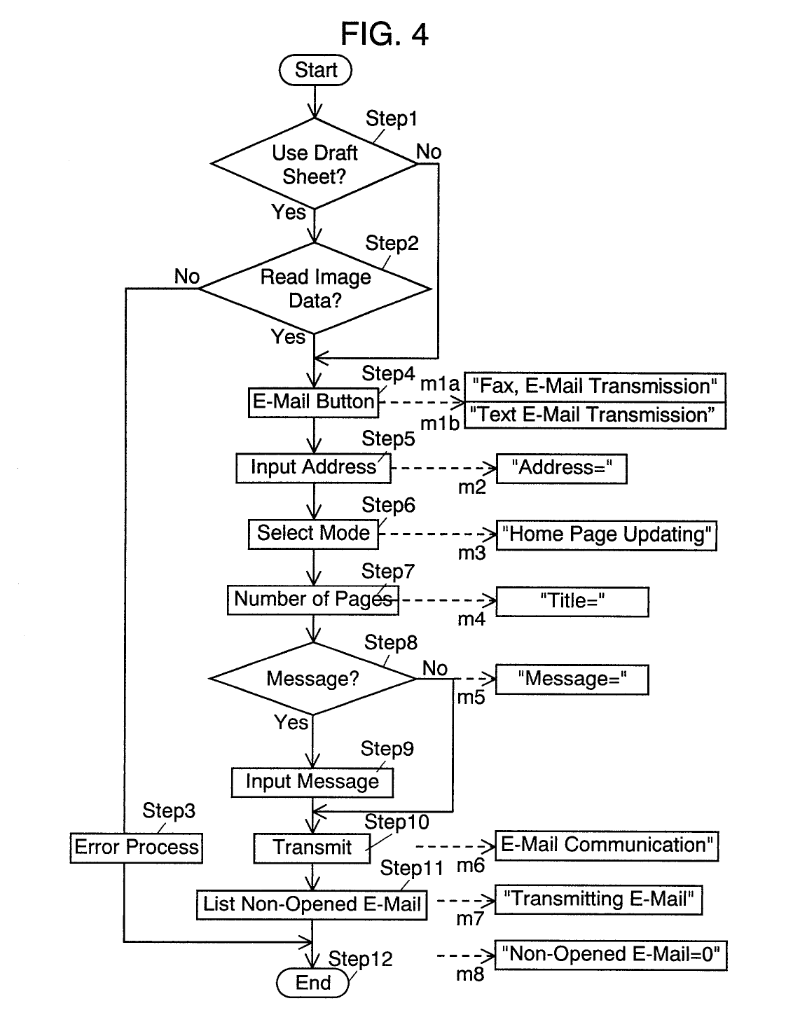

After the completion of the preparatory action, the procedure of producing and updating the home page can be executed. As shown in FIG. 4, first, it is determined whether or not the home page data is provided with the home page producing/updating draft sheet 70 (Step 1). When the home page producing/updating draft sheet 70 is used for providing home page data, the sheet is loaded to the facsimile device in the E-mail mode and scanned for having the home page data read as an image data (Step 2). The home page producing/updating draft sheet 70 is filled by each subscriber or small shop of the lower level user, and is facsimile-transmitted to the provider by the community business society or public organization of an upper level user. If the image data is not scanned at Step 2, the action is treated as an error (Step 3) and the procedure is terminated (Step 12).

If the home page producing/updating draft sheet 70 or hand-written information is not used at Step 1 or the image data is not scanned at Step 2, the E-mail button 5 is pressed (Step 4). Then, the LCD 3 displays a message “Fax, E-Mail Transmission” (m1a) in a facsimile/E-mail mode. In the E-mail mode, “Text E-Mail Transmission” (m1b) is displayed through selecting with the operating dial. When the transmission (start) button 6 is pressed, the LCD 3 displays “Address=” (m2) for instructing a user to input an address, and a mode of producing and updating the home page is selected (Step 5). Then, when the mode for producing and updating the home page is selected with the operating dial instead of the input of the address (Step 6), the LCD 3 displays “Home Page Updating” (m3). Pressing the transmission button 6 initiates the mode. The home page updating may be set up by the input of the address when the address to be input is a predetermined address. In the latter case, the action of mode selection is eliminated.

When the transmission button 6 is pressed again, a message, “Title=”, appears. If the home page has a hierarchy structure composed of the top page and the Web pages, the title is filled with the number of the Web pages to be produced or updated (Step 7). If the home page is produced by the community business society or public organization, the top page is for the upper level user, and the Web pages after the top page where page numbers are listed are for the lower level user of the subscriber. This is not filled when the facsimile/E-mail mode is selected with the page specifying area 73 in the home page producing/updating draft sheet 70 marked up.

When the transmission button switch 6 is pressed down, “Message=”(m5) is displayed to examine whether a message is given or not (Step 8). This is filled with a message in the E-mail mode (Step 9). When the home page producing/updating draft sheet 70 is to be transmitted in the facsimile E-mail transmission mode at Step 8, or when the message is entered at Step 9, the facsimile device calls the CTI server 30 upon button switch 6 being pressed, and a message “E-mail Communication” (m6) is displayed (Step 10). Then, the data is transmitted to the CTI server 30 (Step 11). Then, a message “Transmitting E-mail” (m7) is displayed. During the data transmission, the E-mail controller 28a automatically sends the user ID and the security ID read from the memory 20a. The image data, such as the home page producing/updating draft sheet 70, is transmitted in a G3 facsimile signal form while the text data, such as the messages and the user ID, is transmitted in a Distal Tone Multi-Frequency (DTMF) signal form. The text data may be transmitted in a G3 based protocol form (with a header, such as the transmitter ID data) together with the image data.

When the transmission has been completed, and when an E-mail not transmitted is held at the CTI server 30, the LCD 3 displays a message “Non-Opened E-Mail=1” (m8) for promoting opening of the E-mail (Step 11). Then, the procedure is terminated (Step 12). The facsimile device in the system of the embodiment allows the home page data to be transmitted to the CTI server 30 with the home page producing/updating draft sheet 70, and simultaneously, allows the user ID and security ID to be automatically sent by the E-mail controller 28a.

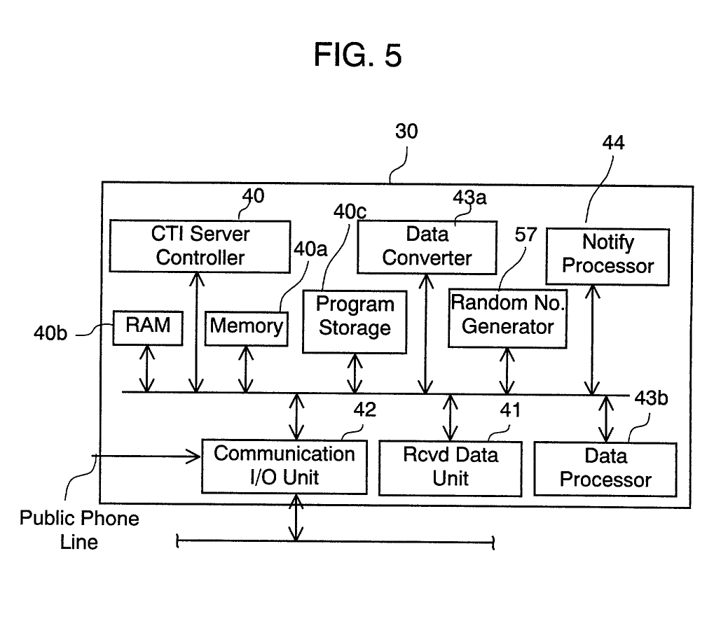

The CTI server of the embodiment will be described in more detail referring to FIG. 5. As described previously, the CTI server is designed at least for handling unified messages produced by a combination of the facsimile function and the E-mail function with a computer. The server (not shown) of the embodiment has a Web function additionally.

FIG. 5 illustrates the CTI server of the embodiment. A memory 40a, such as a non-volatile memory, stores control settings used by a CTI server controller 40 for carrying out controlling actions. A RAM 40b acts as a work area for the controller 40. A program storage 40c stores programs used by the CTI controller 40 for controlling the entire system including the servers. The CTI server controller 40 includes a clock (not shown) for checking and recording the date and time when an E-mail and any notify message is received. A received data unit 41 stores data received from the network.

A communication input/output unit 42 is connected to the public telephone network and the Web for exchanging various protocol data, for controlling the connection, and for transmitting and receiving data. A data converter 43a converts the image data of a facsimile transmissible form, e.g. MR/MH format, received from the facsimile device into a viewable form with a known browser or an Internet transmissible form, e.g. GIF or JPEG format. A data processor 43b retrieves data from the caption area 71, the mobile telephone message area 72, the page specifying area 73, the home page registering mark-sheet area 74, and the home page message area 75 in the home page producing/updating draft sheet 70 which has been received in the form of facsimile image data. Particularly when some of the areas are marked up, the processor 43b correlates location data of the areas corresponding to instructions determined by settings prior to transmission to the Web server 31a (31b).

The image data is developed from the facsimile image data, and then, is compared with a not-filled form of the mark-sheet data previously stored. More particularly, the image data is sized to substantially match the size and location of the not-filled mark-sheet form, and images in the areas of the draft sheet are located in their given positions or ranges. Then, they are compared and calculated for retrieving the images. The data processor 43b distinguishes the text E-mail from the facsimile E-mail, and stores data about them in layout blocks, which will be explained later. If the high-resolution registering area 74c is marked, the format of the data is converted by the data converter 43a and transferred to the Web server 31a (31b). Instructions determined by markings in the mark-sheet boxes are also transferred in the E-mail form to the Web server 31a (31b).

A notify processor 44 produces an E-mail from data received from the facsimile device, and sends it to the Web server 31a. The CTI server 30 includes a random number generator 57. The CTI server in the system of the embodiment has the facsimile function and the E-mail function, but may be divided into two CTI server units: a facsimile server for linking the facsimile function to the computer; and a converter server for carrying out the E-mail function and data processing action. Alternatively, the server unit may be implemented by a combination of the CTI server 30 and the Web server 31a. This can eliminate transmission and reception of E-mails, thus allowing data to be internally transferred in the same manner as with E-mails. In the latter case, the notify processor 44 may not produce an E-mail for directing the Web server 31a to produce the home page but may supply data with a header for producing the home page to data server (Web server 31a). This will be explained later in more detail.

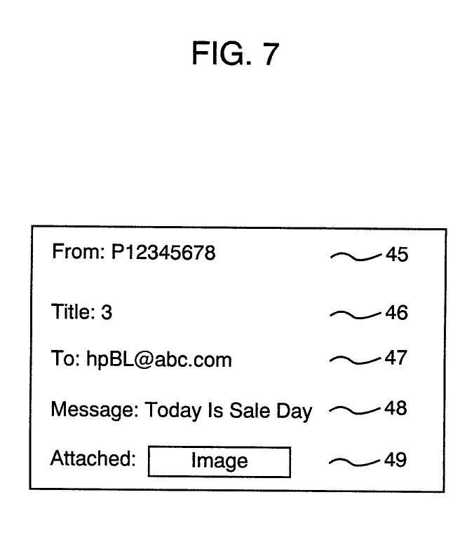

The E-mail generated by the notify processor 44 will be explained referring to FIG. 7. For example, the user ID 45 of “P12345678” includes “5678” representing four lower digits of a facsimile telephone number and “1234” being a random number determined by the random number generator 57. The user ID 45 is not limited to the four lower digits, but its entire digits may represent the facsimile telephone number. If the user ID is co-owned with another, the random number is provided again. Hence, the user ID 45 in not identical to another. The user ID 45 is related to the facsimile telephone number and is preferably used by the Web server 31a (31b) for producing and updating the home page. This allows the facsimile telephone number to be assigned to its corresponding home page. The user ID 45 in the embodiment is a URL password which is determined by a URL manager 56, which is explained later, and is defaulted as title data in the layout block of the top page of the home page. Accordingly, the facsimile telephone number is correlated to its home page securely.

In title 46 (“subject:” on the program), a specified Web page of the home page is written. If the home page contains two or more Web pages, the title represents the number of pages to be produced or updated. If the page specifying area 73 in the home page producing/updating draft sheet 70 is marked, the number of pages recognized by the data processor 43b is written in the title 46. A mail address 47 is a combination of the E-mail address, e.g. “hp@abc.com”, for the Web server 31a (31b) and a control parameter “BL”, hence being, e.g. “hpBL@abc.com”. The control parameter may not be contained in the E-mail address. The E-mail includes text data 48 to be written into the corresponding layout block of the home page and image data 49 received from the scanner 24. If the E-mail is a text E-mail, the E-mail excludes the image data 49. If the E-mail is an image data, the E-mail excludes the text data 48. If the E-mail generated from the home page producing/updating draft sheet 70 is facsimile-transferred, a message, e.g. “Today Is Sale Day”, extracted from the caption area 71 received as the image data is attached to the E-mail, or text data recognized and produced by the image processor 43b is included in the E-mail.

When receiving an E-mail from the facsimile device, an E-mail tagged with the E-mail address “hp@abc.com” is indicative of the production and updating of the home page in the home page updating mode and the CTI server 30 carries out the same process to supply an internal notify signal instead of an E-mail notify message to the Web server 31a (31b). In any case, data of the page is transferred in the mark-sheet form of the page specifying area 73, while the control parameters are transferred in the mark-sheet form of the home page registering mark-sheet area 74.

The control parameters are not notified by a mail address. Mat-sheet items in the home page registering mark-sheet area 74 (including the attached image box 74a, the attached image laid-down box 74b, the high-resolution registering box 74c for the attached image, the daily period registering box 74d, the weekly period registering box 74e, the three-day period registering box 74f, the premium data box 74g, the discount data box 74h, and the coupon data box 74i) and other items in not-defined mark-sheet boxes 74j1, 74j2, . . . , and 74jn are binary digitized and expressed as “0” and “1” in order from the attached image box data 74a. In addition, the user ID “P12345678”, and received date and time, e.g. “200108071500” indicative of 15:00 on Aug. 7, 2001 are combined into data of “P12345678, 200108071500, 0010001000 . . . ” in a CSV format, and the data is then transferred with its header to the Web server 31a (31b).

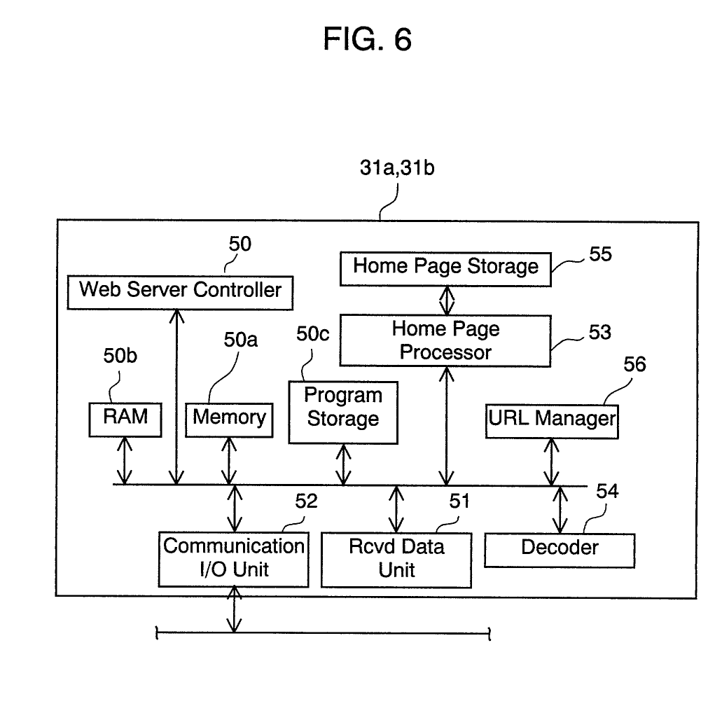

The Web server 31a (31b) and the server unit will be explained referring to FIG. 6. A memory 50a, such as a non-volatile memory, stores the control parameters or settings used by a Web controller 50 for carrying out controlling actions. A RAM 50b functions as a work area for the controller 50. A program storage 50c stores programs used by the Web server controller 50 for controlling the Web server 31a (31b) and the overall system. The Web server controller 50 includes a clock (not shown) for checking and storing the date and time when an E-mail or any notify message is received. A received data unit 51 stores data received from the communication network. A communication input/output unit 52 exchanges protocol data and transmits/receives data. A home page processor 53 produces, registers, and updates a home page on the Web server 31a (31b). A decoder 54 extracts the control parameters from the E-mail address 47 of a received E-mail, and then decodes the layout blocks to be processed and home page producing parameters which are location data arranged in a lateral direction. When the notify message is received by the notify processor 44, the decoder 54 decodes digital data in the CSV format representing the user ID, the control parameters, and the home page producing parameters. A home page storage 55 is provided for storage of the home pages registered. The URL manager 56 controls the URL of each home page.

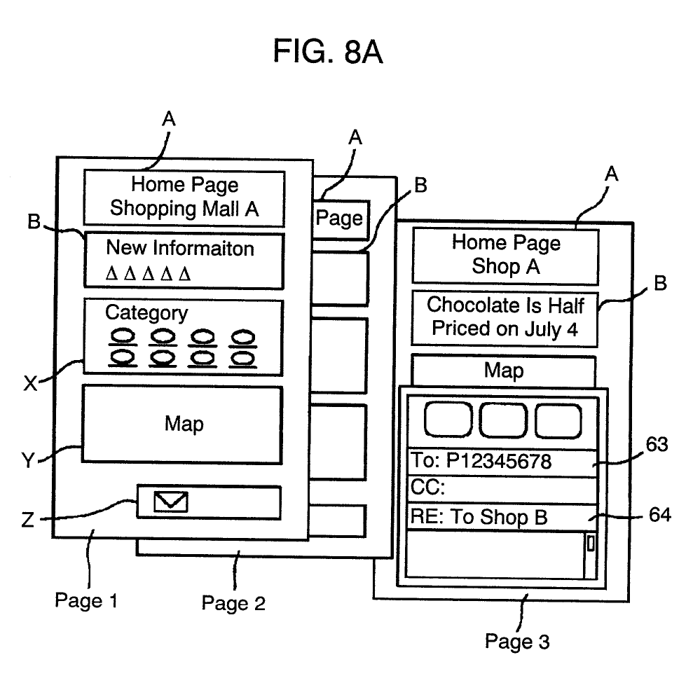

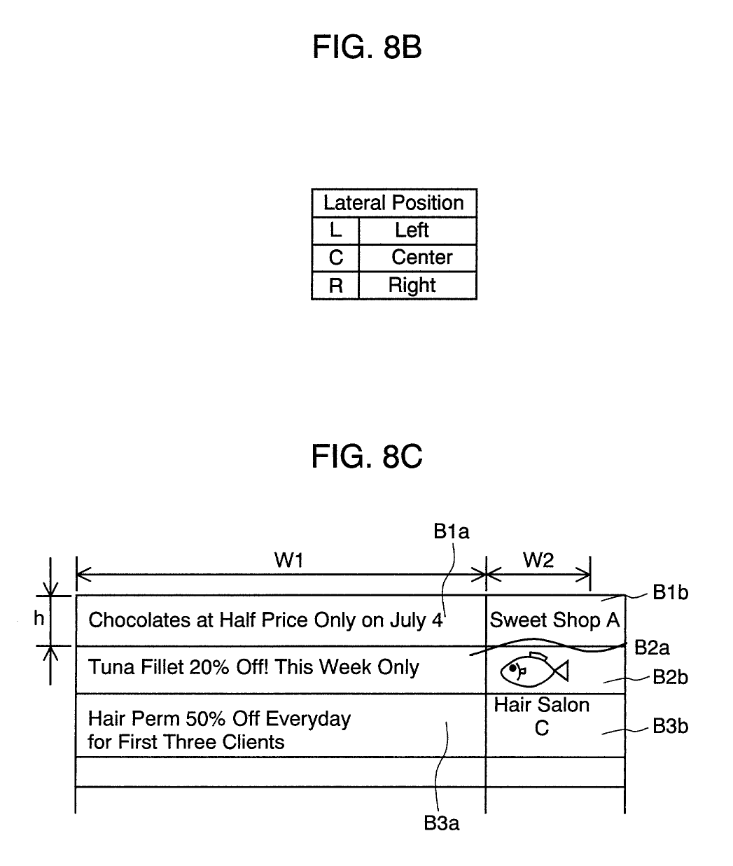

As described in above, the URL of this embodiment includes a number which is common to the user ID 45 assigned to the facsimile telephone number as the password. More specifically, the URL is composed of the password, the domain name, and the user ID 45. For example, the URL is expressed by “http://www.domain name/user ID”. The user ID of “P12345678” contains “5678” as the four lower digits of the facsimile telephone number and “1234” as the random number determined by the random generator 57. Hence, the URL become “http://www.domain name/P12345678”. Upon the domain name being “xxx.co.jp”, the URL of the top page of the home page consisting of three pages has its URL of “http://www.xxx.co.jp/P12345678/”. The third page thus has its URL of “http://www.xxx.co.jp/P12345678/003/”. If the top page is produced by a community business society or public organization, the page of page number “3” shown in FIG. 8A represents the home page (a Web page) of a shop C.

If the mobile telephone home page message area 72 in the home page producing/updating draft sheet 70 is filled with a message, the URL is then turned to “http://www.xxx.co.jp/P12345678/i/”. Since the E-mail address for the Web server 31a (31b) is “hp@abc.com”, the servers including the Web server 31a may share a location. Accordingly, the domain name “xxx.co.jp” may be replaced by commonly-applicable “abc.com”. Also, the user ID 45 of “P12345678” is assigned to the E-mail address of a single facsimile throughout the world. Then, the E-mail address is expressed by “P12345678@yyy.com” including the user ID of “P12345678”.

In the embodiment, the user ID 45 and the URL may employ other numbers related to their respective facsimile telephone numbers.

As described above, in the embodiment, the user ID 45 is assigned to both the facsimile telephone number and the URL. This prevents the URL from overlapping with another. Accordingly, the subscriber or user may need to memorize only its facsimile telephone number, and can thus control its home page easily.

Referring to FIGS. 8A and 8B, the home page produced by the Web server 31a (31b) in the system of the embodiment contains some editable layout blocks A, B, C, . . . , Y, and Z of a format for displaying images serving as a browser. The layout blocks A to Z have different patterns. The layout blocks shown in FIG. 8A are arranged in vertically-extending rectangular shapes. The layout blocks may have their sizes defined by FORM tags in an HTML format.

In this embodiment, the layout block A carries a caption or title where the user ID assigned to the facsimile telephone number (the URL password) is written as default data. In case the home page is produced by a community business society or public organization, its top page carries the default user ID, such as a name of a shop, and the Web page of each shop or subscriber is identified with a page user name.

The home page producing parameters shown in FIG. 8B are control parameters for instructing the location in a lateral direction of a text in the layout block. A letter “L” instructs the location of the text to be at the left. A letter “C” instructs the location of the text to be at the center. A letter “R” instructs the location of the text to be at the right. As described above, the number of pages is determined in the title of the E-mail. For example, the text shifts to the left in the layout block B shown in FIG. 8B. This location is defined by a control parameter “BL” and is expressed by a mail address “hpBL@abc.com” having a control function. If the data includes both text and an image, the location of the text only is specified by the control parameter. If no layout block is specified by the control parameter, a layout block can be produced or updated. This allows the home page to be produced and updated simply.

The control parameters in the E-mail are not limited to the definition of the location, but may be assigned for controlling the items in the mark-sheet of the home page registering mark-sheet area 74 (the attached image box 74a, the attached image laid-down box 74b, the high-resolution registering box 74c for attached image, the daily period registering box 74d, the weekly period registering box 74e, the three-day period registering box 74f, the premium data box 74g, the discount data box 74h, and the coupon data box 74i).

For displaying the latest information as the caption message of a web page, the layout block B may be divided into sub-blocks B1a, . . . , Bna, B1b, . . . , and Bnb (caption-listing sub-blocks), as shown in FIG. 8C. The sub-blocks B1a to Bna are filled with the caption messages as image data which have been written by the Web page user in the caption area 71 of the home page producing/updating mark-sheet 70. The sub-blocks B1b to Bnb (caption-source sub-blocks) are filled with user names or logo marks relating to the caption messages. Each of the sub-blocks B1a to Bna is allocated to each subscriber or Web page user, and this allows its latest information to be shown.

Information in the sub-blocks B1a, . . . , Bna, B1b, . . . , Bnb may be displayed in chronological order, i.e. the latest received information is first displayed. This allows a viewer to know at glance which Web page carries the latest information and to easily receive every up-to-date message. Other sub-blocks B1c to Bnc (not shown) may be provided for indicating the date and time when the information is received or updated. The date and time in the other sub-blocks represents when the latest information is received by the Web server or when the Web page is updated by the Web server.

In that case, the E-mail address of each Web page user or subscriber is expressed by e.g. “hpBiaX@abc.com” (i=1 to n and X=L, C or R). The decoder 54 decodes each mail address and transfers the decoded address together with the message or image data to the home page processor 53. In turn, the home page processor 53 stores the image data and the control parameters in relation to the user ID which has been received through the user identification process.

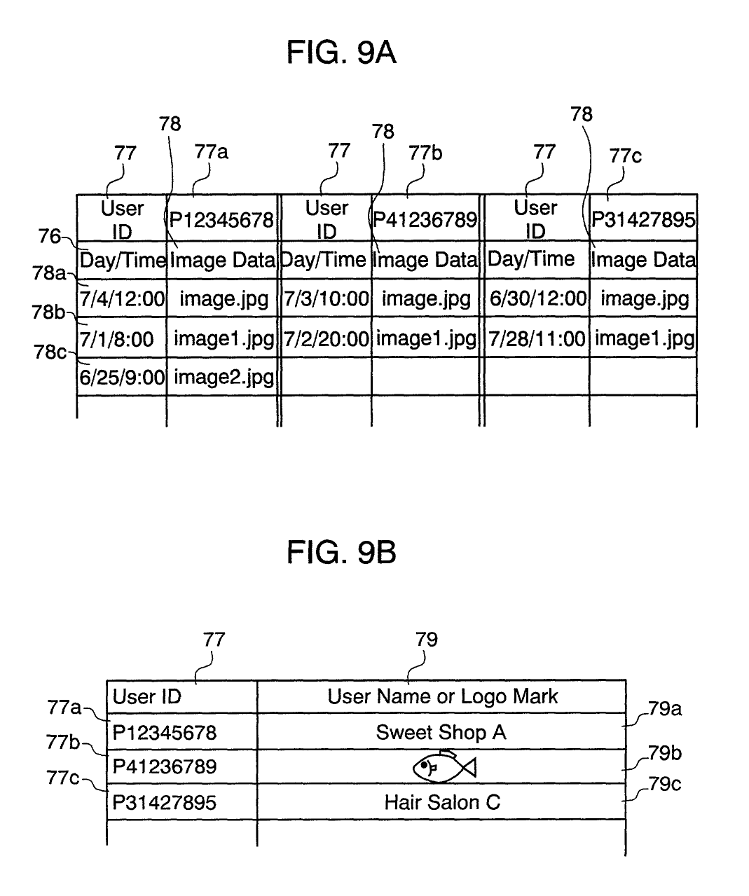

Referring to FIG. 9A, the user ID boxes 77 hold three user IDs 77a, 77b, and 77c, respectively. Each user ID is assigned the date and time 76 when the E-mail or notify message is received and the caption message data 78. For example, when the E-mail or notify message is received from the user ID 77a, the data and time data “7/4/12:00” and image data file “image.jpg” are recorded. More specifically, the existing image data file imageN.jpg is stored with N being incremented as “image1.jpg”, “image2.jpg”, and “image3.jpg”. FIG. 9A illustrates the user ID 77a of “P12345678” providing the latest image data 78a of “image.jpg”. The user of the user ID 77b sends the image data 78b of “image1.jpg” after the user of the user ID 77a. The third latest image data 78c of the user ID 77a is “image2 jpg”.

The user name is recorded in the memory 50a in relation to its user ID and Web page information as shown in FIG. 9A. FIG. 9B illustrates the user IDs assigned to the Web page user names 79 filled in the sub-blocks B1b to Bnb, respectively. The Web page user name may be replaced by shop names or logo marks. For example, the user names 79a and 79c are shop names, and the user name 79b is a logo mark. Each user name is related to its user ID and page information, and has preliminarily been stored in the memory 50a.

The action of the home page processor 53 will be explained. The home page processor 53 reads the image data 78 of each user ID and its user name 79 from the memory 50a, and allocates them to the sub-blocks B1a, B2a, B3a and B1b, B2b, B3b in the layout block. As a result, on the top page, a list of the messages are displayed as shown in FIG. 8C.

As shown in FIG. 8C, the latest information is the image data of “image.jpg” of a sweet shop A received on “7/4/12:00”, and the image data indicates that “Chocolate Is Half Priced on July 4”. The second latest information is the image data of “image.jpg” of a fishery shop B received on “7/3/10:00”. The data indicates that “Tuna Fillet 20% Off! This Week Only”. The third latest information is the image data of “image.jpg” received on “6/30/20:00”. The data indicates that “Hair Perm 50% Off Everyday for First Three Clients”. In this embodiment, each of the user IDs 77a, 77b, and 77c is assigned with one caption message to be displayed. Accordingly, the home page processor 53 reads the caption message of the user ID 77c received on “6/30/20:00” from the memory 50a using its CGI function, hence allowing the latest information of the user ID 77c to be displayed on the top page of the home page.

If the latest information is displayed in chronological order, the caption message on “7/4/12:00” of the user ID 77a is displayed, and then, the message on “7/3/10:00” of the user ID 77b and the message on “6/30/20:00” of the user ID 77c are displayed.

The caption message source blocks B1b to Bnb may be assigned to lower level page sources and constructed by the HTML or CGI format for linking to the lower level pages. In this case, the linked sources are preliminarily stored together with their names, IDs, and page information in the memory 50a.

If the sub-blocks B1a to Bna of the layout block B are filled with the image data, and if the sub-blocks B1b to Bnb are filled with the user IDs, the home page processor 53 conducts the following action. As shown in FIG. 8C, the sub-blocks B1a to Bna have widths w1 and heights h, and the sub-blocks B1b to Bnb have widths w2 and heights h. In this embodiment, the width w1 of the sub-blocks B1a to Bna is set to 420 dots, while the width w2 of the sub-blocks B1b to Bnb is set to 120 dots. The home page processor 53 adjusts the sub-blocks to have sizes of 100% of the layout block frame regardless of any change in the overall dimensions of the home page producing/updating draft sheet 70. In the HTML format, the sizes may be defined by “width=100%”.

As shown in FIG. 8C, a ratio w1/h of the width to the height of each of the sub-blocks B1a to Bna is not smaller than 2. The ratio w1/h ranges preferably from 5 to 20, more preferably from 12 to 15. If the ratio w1/h stays in the above mentioned range, the messages which are mostly hand written and retrieved from the caption message areas 71 of the home page producing/updating draft sheet 70 can be highly legible on the home page and their information can be maximum within the sub-blocks B1a to Bna. The hand written messages as the image data in the sub-blocks B1a to Bna can thus be viewed as listed together with their related user IDs in the sub-blocks B1b to Bnb.

Items in the home page registering mark-sheet box 74 of the draft sheet 70, e.g. the period data 74d, 74e, and 74f, may be assigned to the message displaying sub-blocks B1a to Bna for deleting image data from the layout block of the home page and for deleting message data from the sub-blocks B1a to Bna after a given period of time.

The CTI server 30 and the Web server 31a may be joined to each other to construct a single server unit having their functions. As the single server unit includes the CTI server 30 shown in FIG. 5 and the Web server 31a shown in FIG. 6, the communication input/output unit, the RAM, the memory, and the received data unit can be commonly provided. In action, the notify processor 44 supplies an internal notify message to the home page processor 53 instead of the E-mail for producing the home page. The other fundamental actions carried out by the Web server 31a including the attaching of the caption messages of the Web page user to the sub-blocks B1a to Bna for displaying messages can be conducted by the server unit, and is explained in no more detail.

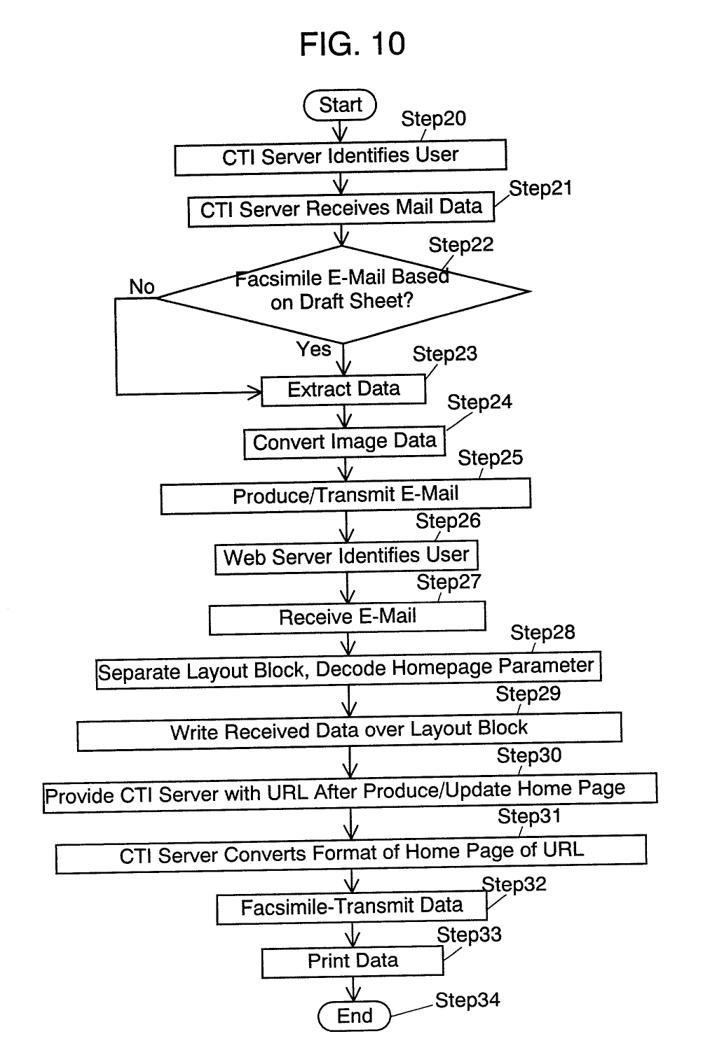

The producing and updating of the home page after the E-mail or the data of producing a notify message transferred from the facsimile device to the CTI server 30 or the server unit will be described. FIG. 10 is a flowchart of procedure after the facsimile message of the system of the embodiment receives data. Upon receiving a signal from the facsimile device, the CTI server 30 or server unit carries out the user identification using the user ID and security ID (Step 20). Since the user ID is related to the facsimile telephone number T and is defined by the URL, the URL is not overlapped with another. After the identification is normally completed, the subscriber sends text data or image data as an E-mail from its facsimile device, or provides the image data on the home page producing/updating draft sheet 70.

The CTI server 30 receives the text data and/or image data in the E-mail or the facsimile data of the home page producing/updating draft sheet 70, and stores them together with the E-mail address in the received data unit 41 (Step 21).

If the data is facsimile data on the home page producing/updating draft sheet 70 (Step 22), the image processor 43b extracts the mark-sheet data (including the instructions) from the caption area 71, the mobile telephone home page registering area 72, the page specifying area 73, the home page registering mark-sheet area 74, and the home page message area 75 (Step 23).

The extracted image data and instructions are related to each other and stored in the received data unit 41. More particularly, the data can be stored after automatic recognition of characters determined by the data converter 43a. If the extracted data is received in an E-mail, the procedure advances directly to Step 24 without the character recognition.

Then, the facsimile data, if it includes no characters but only image data, is converted into the Internet transmittable data format (Step 24). The converted image data is then transferred to the communication processor 44 where the data is used for producing an E-mail which is transmitted to the Web server 31a (31b) (Step 25). The converted image data is transmitted as a file attached to the E-mail. Simultaneously, the data in the home page registering mark-sheet area 74 are transmitted. Upon receiving the E-mail, the Web server 31a (31b) carries out the user identification using the user ID and a security ID (Step 26). After the user identification, the Web server 31a (31b) stores the E-mail address along with the received text data and/or image data in the received data unit 41 (Step 27).

Then, the decoder 54 separates the layout block of the control parameters and the home page producing parameters from the E-mail address (Step 28).

Upon receiving location data as the home page producing parameters and the layout block data, the home page processor 53 identifies the number of pages from the digits received as title data, and fills the layout block for editing a home page with the text data and the image data received from the received data unit 51. For updating the home page, new data received is written over existing data. As a result, the new data is set up, and the existing data is eliminated. After the action of producing the home page is completed, the home page processor 53 registers and stores the home page in the home page storage 55 (Step 29).

The data in the home page registering mark-sheet box 74 of the draft sheet 70, e.g. the period data 74d, 74e, or 74f, may be assigned to the layout blocks for deleting the image data from the layout block after a given period of time. The search key data 74g, 74h, and 74i may be correlated to the layout blocks for searching image or other data from the layout blocks.

Then, the home page processor 53 notifies the CTI server 30 of the URL of the newly-produced home page controlled by the URL manager 56 (Step 30). Then, the CTI server 30 obtains data of the home page based on the URL. The data is converted by the data converter 43 into a facsimile transmissible form (Step 31), and is transmitted to the facsimile device 1 (Step 32). The home page received is printed by the printer unit 25 in the facsimile device 1 (Step 33), and the procedure is terminated (Step 34).

As described above, in the method of producing and updating a home page of the embodiment, the data can be written in each layout block and does not need character recognition on the image data. The method enables the home page to be produced and updated with an existing communications system where E-mails are exchanged with facsimile machines. Since locations of the data are defined by the control parameters, the text data and/or the image data in the layout blocks can easily be positioned on the home page through the instructions sent as the E-mail. Since the user ID is correlated to both the facsimile telephone number and the URL, the URL is not overlapped with another.

The home page producing/updating draft sheet in the system of the embodiment can include the image data and the mark-sheet data written on the sheet. The mark-sheet data includes page information, and a location of a mark allows the system to recognize the instructions. Accordingly, each Web page of the home page can be specified through marking the mark-sheet, thus contributing to an easy action of producing and updating the home page.

The facsimile device in the system of the embodiment is designed for producing home pages in a dialog manner, hence allowing each user or subscriber to produce and update home pages even if he/she does not understand computers or networks.

Since being written simply in the E-mail address, the control parameters can easily be read by the CTI server in the system of the embodiment. Accordingly, the production and updating of the home page can be conducted by transmitting the E-mail from the facsimile device to the Web server over any existing communications system. The user ID assigned to the facsimile telephone number may be used for the user identification. Accordingly, the URL of the user is not overlapped with another.

Moreover, the system for producing and updating a home page of the embodiment can extract the layout blocks and the home page producing parameters from the address of the E-mail. This allows the Web server to write the text data and/or the image data in every layout block without an operation of any computer for uploading the home page. Accordingly, the production and updating of the home page can be instructed by the E-mail transmitted from the facsimile device to the Web server over any existing communications system without troublesome character recognition.

Many modifications and variations of the present invention are possible in the light of the above techniques. It is therefore to be understood that within the scope of the invention, the invention may be practiced otherwise than as specifically described.

### INDUSTRIAL APPLICABILITY

A method for producing and updating a home page of the present invention enables a subscriber who has no particular knowledge about computers and the Internet to produce and update a home page easily and inexpensively without disturbing a home page operator. A caption message received as image data can be displayed on a top page of the home page as it is.

What is claimed is:

1. A method of producing and updating a home page, comprising the steps of:
transmitting, from a facsimile to a server unit, image data and mark-sheet data written on a home page producing/updating draft sheet which has a home page data area, a caption data area, and a mark-sheet setting area;
allowing the server unit to convert a format of the transmitted image data;
allowing the server unit to recognize an instruction from a location of the mark-sheet data in the mark-sheet data setting area;
allowing the server unit to write the image data into a layout block of a home page for producing or updating the home page;
allowing the server unit to extract a caption image from the caption data area; and
allowing the server unit to write the caption image into a caption-listing sub-block in the layout block on a top page of the home page.

2. A method according to claim 1, wherein the server unit comprises:
a computer telephony integration (CTI) server for receiving an image from the home page producing/updating draft sheet received from the facsimile, for extract block data, and for converting the format of the image data; and
a Web server for writing the data received from the CTI server into the layout block for producing and updating the home page.

3. A method of producing and updating a home page which has a layout block, wherein a home page producing/updating draft sheet has a home page data area, a caption data area, and a mark-sheet data setting area, said method comprising the steps of:
transmitting, from a facsimile to a computer telephony integration (CTI) server, a certain mail address indicative of producing and updating the home page, a user ID assigned to a telephone number of the facsimile, and data in the home page producing/updating draft sheet including image data and mark-sheet data;
allowing the CTI server to extract a plurality of block data corresponding to the layout block;
allowing the CTI server to convert a format of image data in the plurality of extracted block data;
allowing the CTI server to recognize an instruction from a location of the mark-sheet data of the plurality of extracted block data;
sending the image data and the instruction from the CTI server to a Web server storing the home page;
allowing the Web server to write data sent from the CTI server into the layout block for producing or updating the home page; and
allowing the Web server to write a caption message extracted from the caption data area into of a caption-listing sub-block in the layout block on a top page of the home page.

4. A method according to claim 3, wherein the CTI server produces a notify message and sends the notify message to the Web server instead of sending an E-mail including a certain E-mail address indicative of producing and updating the home page.

5. A method of producing and updating a home page which employs a home page producing/updating draft sheet having a home page data area, a caption data area, a mark-sheet data setting area, and page data, said method comprising the steps of:
transmitting, from a facsimile to a server, a mail address indicative of producing and updating the home page, a user ID assigned to a telephone number of the facsimile, and image data and mark-sheet data provided in the home page producing/updating draft sheet;
allowing the server to convert a format of the image data;
allowing the server to recognize an instruction from a location of the mark-sheet data in the mark-sheet data setting area;
allowing the server to write the image data into a layout block of the home page for producing or updating the home page;
extracting a caption message of the image data from the caption data area;
writing the caption message into a caption-listing sub-block in the layout block on a top page of the home page;
allocating the top page to an upper lever user assigned with the user ID; and
if a Web page is assigned to a successive page in the home page, processing the page data as indicating the continuing page.

6. A method according to claim 5, wherein the successive page is allocated to a lower level user which have no user ID.

7. A method according to claim 5, wherein the successive page is allocated to the upper level user.

8. A home page producing/updating draft sheet comprising:
a first area where image data is provided; and
a second area where mark-sheet data including page data and caption message data of a home page is provided,
wherein a page is identified by recognizing a location of mark-sheet data of the page data, and
wherein data is written into a layout block on the page corresponding to the page data to produce or update the home page.

9. A home page producing/updating draft sheet according to claim 8, wherein the second area includes a caption-listing sub-block where image data in the caption message is provided, the caption-listing sub-block having a rectangular shape of a lateral-to-vertical ratio not smaller than 2.

10. A home page producing/updating draft sheet according to claim 6, wherein the mark-sheet data indicative a presence and absence of an attached image.

11. A facsimile comprising:
a communication input/output unit for transmitting and receiving data over a communications network;
a display for displaying for inputting data in a dialog manner;
a dialog controller for directing the display to initiate a production of a home page in the dialog manner and for facsimile-transmitting data for producing an E-mail;
an input unit for conducting an input of the data for producing the E-mail;
a scanner for scanning an image;
a home page producing mode selector for selecting a mode to produce and update the home page; and
an E-mail controller for facsimile-transmitting the data for producing the W-mail to a computer telephony integration (CTI) server,
wherein, for producing or updating the home page, the E-mail controller supplies, to the CTI server, a user ID assigned to a telephone number of the facsimile, and
wherein the dialog controller conduct an input of a certain mail address indicative of producing or updating the home page, and directs an input of data with a home page producing/updating draft sheet.

12. A computer telephony integration (CTI) server comprising:
a communication input/output unit for receiving data for producing an E-mail, the data being facsimile-transmitted through being written on a home page producing/updating draft sheet which includes image data and mark-sheet data;
a data processor for extracting block data corresponding to a layout block of a home page from the data, and for recognizing an instruction from a location of mark-sheet data of the extracted block data; and
a data format converter for converting the image data in the extracted block data from a facsimile-transmissible format to an Internet-transmissible format,
wherein the data processor extracts a caption message of the image data from the home page producing/updating draft sheet,
wherein the communication input/output unit supplies, to a Web server, an E-mail to a certain mail address indicative of producing or updating the home page, the E-mail including one of the recognized instruction for a writing in the layout block and the image data of the converted format to be written into the layout block, and
wherein the data processor extracts a caption message of the image data from the home page producing/updating draft sheet.

13. A computer telephony integration (CTI) server comprising:
a communication input/output unit for receiving data for producing an E-mail, the data being facsimile-transmitted through being written on a home page producing/updating draft sheet which includes image data and mark-sheet data;
a data processor for extracting block data corresponding to a layout block of a home page from the data, and for recognizing an instruction from a location of mark-sheet data of the extracted block data; and
a data format converter for converting image data of the extracted block data from a facsimile-transmissible format to an Internet-transmissible format,
wherein the data processor extracts a caption message of the image data from the home page producing/updating draft sheet,
wherein the communication input/output supplies, to a Web server, a notify message indicative of producing or updating of the home page, the notify message including one of the recognized instruction for a writing in the layout block and the image data of the converted format to be written in the layout block, and
wherein the data processor extracts a caption message of the image data from the home page producing/updating draft sheet.

14. A Web server comprising:
a home page processor for writing data extracted and processed by a computer telephony integration (CTI) server into a layout block of a home page;
a decoder for decoding a control parameter from an E-mail address of an E-mail or a notify message produced by the CTI server in response to data from a facsimile, and for supplying, to the home page processor, a name of the layout block on a page to be processed and control data;
a memory for storing received data;
a home page storage for storing the home page; and
a URL manager for storing and controlling a URL of the home page,
wherein the home page processor, according to a recognized instruction, writes image data of a converted format into the layout block decoded by the decoder to produce or update the home page, and writes a caption image extracted by the CTI server into a caption-listing sub-block in the layout block on a top page of the home page.

15. A server unit comprising:
a communication input/output unit for receiving data facsimile-transmitted with using a home page producing/updating draft sheet which carries caption image data;
a data processor for extracting the caption image data from the received data;
a data format converter for converting the caption image data from a facsimile-transmissible format to an Internet-transmissible format; and
a controller for selecting one of a plurality of caption-listing sub-blocks to be displayed on a top page of a home page, and pasting the caption image data of the converted format to the selected one of the plurality of caption-listing sub-blocks.

16. A server according to claim 15, wherein each of the plurality of caption-listing sub-blocks has a rectangular shape of a lateral-to-vertical ratio not smaller than 2.

17. A server according to claim 15, wherein the data processor extracts, as the caption image data, data of a portion corresponding to a certain area on the home page producing/updating draft sheet received as facsimile data by the communication input/output unit.

18. A server according to claim 15, wherein the controller pastes caption image data of a lower level user a reference caption-listing sub-block, the caption image data being received at latest date and time based on date and time when the caption image data is received, and displays the date and time next to the reference caption-listing sub-block to which the caption image data of the lower level user is pasted.

19. A server according to claim 17, wherein the caption image data is assigned to a Web page of the lower level user.

20. A server according to claim 15, wherein the communication input/output unit can receive image data to be displayed on a corresponding Web page of the lower level user, and the image data is sent together with the caption image data on the home page producing/updating draft sheet or a successive sheet from a facsimile.

21. A server according to claim 20, wherein the caption image data is assigned to a Web page of the lower level user.

22. A server according to claim 20, wherein the controller stores page user data assigned to the lower level user or the Web page of the lower level user, and pastes the page user data to a caption-source sub-block related to the caption-listing sub-block.

23. A server according to claim 22, wherein a link destination for link to the Web page of the lower level user is allocated to the caption-source sub-block.

24. A server according to claim 20, wherein, if a plurality of caption messages image data assigned to the Web page of the lower level user are received at different date and time, caption image data received at latest date and time is pasted to the caption-listing sub-block.

25. A server according to claim 15,
wherein the communication input/output unit receives deleting-instruction data together with the caption image data, the deleting-instruction data indicative of deleting the caption image data after a period, and
wherein the data processor extracts the deleting-instruction data and writes the data of the converted format into the caption-listing sub-block in relation to the deleting-instruction data.

26. A home page producing and updating system comprising:
a facsimile for transmitting data on a home page producing/updating draft sheet which has a home page data area, a caption data area, and a mark-sheet data setting area where image data and mark-sheet data are carried; and
a server unit operable to:
receive the data from the facsimile;
convert a format of the image data of the received data;
recognize an instruction from a location of the mark-sheet data on the mark-sheet data setting area;
write the image data into a layout block to produce or update a home page; and
write a caption image data extracted from the caption message area into a caption-listing sub-block of the layout block on a top page of the home page.

27. A home page producing and updating system according to claim 26, wherein the server unit comprises:
a computer telephony integration (CTI) server for receiving the data on the home page producing/updating draft sheet from the facsimile and for converting the format of the image data of block data extracted from the received data; and
a Web server for writing the data received from the CTI server into a layout block to produce or update the home page.

28. A home page producing and updating system comprising:
(a) a facsimile comprising:
(a-1) a communication input/output unit for transmitting and receiving data over a communications network;
(a-2) a display for displaying for inputting data in a dialog manner;
(a-3) a dialog controller for directing the display to initiate a production of a home page in the dialog manner and for facsimile-transmitting data for producing an E-mail;
(a-4) an input unit for conducting an input of the data for producing the E-mail;
(a-6) a scanner for scanning an image;
(a-6) a home page producing mode selector for selecting a mode to produce and update the home page; and
(a-7) an E-mail controller for facsimile-transmitting the data for producing the W-mail, wherein, for producing or updating the home page, the E-mail controller supplies a user ID assigned to a telephone number of the facsimile, and wherein the dialog controller conduct an input of a certain mail address indicative of producing or updating the home page, and directs an input of data with a home page producing/updating draft sheet;
(b) a computer telephony integration (CTI) server comprising:
(b-1) a communication input/output unit for receiving data for producing an E-mail, the data being facsimile-transmitted through being written on a home page producing/updating draft sheet which includes image data and mark-sheet data;
(b-2) a data processor for extracting block data corresponding to a layout block of a home page from the data, and for recognizing an instruction from a location of mark-sheet data of the extracted block data; and
(b-3) a data format converter for converting the image data in the extracted block data from a facsimile-transmissible format to an Internet-transmissible format, wherein the data processor extracts a caption message of the image data from the home page producing/updating draft sheet, wherein the communication input/output unit supplies an E-mail to a certain mail address indicative of producing or updating the home page, the E-mail including one of the recognized instruction for a writing in the layout block and the image data of the converted format to be written into the layout block, and wherein the data processor extracts a caption message of the image data from the home page producing/updating draft sheet; and
(c) a Web server comprising:
(c-1) a home page processor for writing data extracted and processed by a computer telephony integration (CTI) server into a layout block of a home page;
(c-2) a decoder for decoding a control parameter from an E-mail address of an E-mail or a notify message produced by the CTI server in response to data from a facsimile, and for supplying, to the home page processor, a name of the layout block on a page to be processed and control data;
(c-3) a memory for storing received data;
a home page storage for storing the home page; and
a URL manager for storing and controlling a URL of the home page, wherein the home page processor, according to a recognized instruction, writes image data of a converted format into the layout block decoded by the decoder to produce or update the home page, and writes a caption image extracted by the CTI server into a caption-listing sub-block in the layout block on a top page of the home page,
wherein, according to the E-mail generated by the CTI server and transmitted by facsimile, the converted image data is written in the layout block decoded by the decoder of the Web server according to the recognized instruction.

29. A home page producing and updating system comprising:
(a) a facsimile comprising:
(a-1) a communication input/output unit for transmitting and receiving data over a communications network;
(a-2) a display for displaying for inputting data in a dialog manner;
(a-3) a dialog controller for directing the display to initiate a production of a home page in the dialog manner and for facsimile-transmitting data for producing an E-mail;
(a-4) an input unit for conducting an input of the data for producing the E-mail;
(a-5) a scanner for scanning an image;
(a-6) a home page producing mode selector for selecting a mode to produce and update the home page; and
(a-7) an E-mail controller for facsimile-transmitting the data for producing the W-mail, wherein, for producing or updating the home page, the E-mail controller supplies a user ID assigned to a telephone number of the facsimile, and wherein the dialog controller conduct an input of a certain mail address indicative of producing or updating the home page, and directs an input of data with a home page producing/updating draft sheet;
(b) a computer telephony integration (CTI) server comprising:
(b-1) a communication input/output unit for receiving data for producing an E-mail, the data being facsimile-transmitted through being written on a home page producing/updating draft sheet which includes image data and mark-sheet data;
(b-2) a data processor for extracting block data corresponding to a layout block of a home page from the data, and for recognizing an instruction from a location of mark-sheet data of the extracted block data; and
(b-3) a data format converter for converting image data of the extracted block data from a facsimile-transmissible format to an Internet-transmissible format, wherein the communication input/output supplies a notify message indicative of producing or updating of the home page, the notify message including one of the recognized instruction for a writing in the layout block and the image data of the converted format to be written in the layout block, and wherein the data processor extracts a caption message of the image data from the home page producing/updating draft sheet; and
(c) a Web server comprising:
(c-1) a home page processor for writing data extracted and processed by a computer telephony integration (CTI) server into a layout block of a home page;
(c-2) a decoder for decoding a control parameter from an E-mail address of an E-mail or a notify message produced by the CTI server in response to data from a facsimile, and for supplying, to the home page processor, a name of the layout block on a page to be processed and control data;
(c-3) a memory for storing received data;
(c-4) a home page storage for storing the home page; and
(c-5) a URL manager for storing and controlling a URL of the home page, wherein the home page processor, according to a recognized instruction, writes image data of a converted format into the layout block decoded by the decoder to produce or update the home page, and writes a caption image extracted by the CTI server into a caption-listing sub-block in the layout block on a top page of the home page,
wherein, according to the E-mail generated by the CTI server and transmitted by facsimile, the converted image data is written in the layout block decoded by the decoder of the Web server according to the recognized instruction.

30. A home page producing and updating system comprising:
(a) a facsimile comprising:
(a-1) a communication input/output unit for transmitting and receiving data over a communications network;
(a-2) a display for displaying for inputting data in a dialog manner;
(a-3) a dialog controller for directing the display to initiate a production of a home page in the dialog manner and for facsimile-transmitting data for producing an E-mail;
(a-4) an input unit for conducting an input of the data for producing the E-mail;
(a-5) a scanner for scanning an image;
(a-6) a home page producing mode selector for selecting a mode to produce and update the home page; and
(a-7) an E-mail controller for facsimile-transmitting the data for producing the W-mail, wherein, for producing or updating the home page, the E-mail controller supplies a user ID assigned to a telephone number of the facsimile, and wherein the dialog controller conduct an input of a certain mail address indicative of producing or updating the home page, and directs an input of data with a home page producing/updating draft sheet; and
(b) a server unit comprising:
(b-1) a communication input/output unit for receiving data facsimile-transmitted with using a home page producing/updating draft sheet which carries caption image data;
(b-2) a data processor for extracting the caption image data from the received data;
(b-3) a data format converter for converting the caption image data from a facsimile-transmissible format to an Internet-transmissible format; and
(b-4) a controller for selecting one of a plurality of caption-listing sub-blocks to be displayed on a top page of a home page, and pasting the caption image data of the converted format to the selected one of the plurality of caption-listing sub-blocks,
wherein, according to the E-mail generated by the CTI server and transmitted by facsimile, the converted image data is written in the layout block decoded by the decoder of the Web server according to the recognized instruction.
